(19) United States
(12) Patent Application Publication
(10) Pub. No.: US 2007/0121820 A1
(43) Pub. Date: May 31, 2007

(54) SYSTEM AND PROCESS FOR CONTROLLING THE SENDING OF INFORMATION TO SUBSCRIBERS

(76) Inventor: CHRISTIAN N. AHMANN, FRANKFURT am MAIN (DE)

Correspondence Address: WILLIAM COLLARD;COLLARD & ROE, P.C., 1077 NORTHERN BOULEVARD, ROSLYN, NY, 11576, US

(21) Appl. No.: 11/559,034

(22) Filed: Nov. 13, 2006

(30) Foreign Application Priority Data
Nov. 14, 2005 (DE) DE102005054160.7
Feb. 13, 2006 (DE) DE102006006414.3
Apr. 11, 2006 (DE) DE102006015246.8
May 13, 2006 (DE) DE102006022145.5
Sep. 21, 2006 (DE) DE102006044569.4

(51) Int. Cl. H04M 11/00

(52) U.S. Cl. 379/88.13

(57) ABSTRACT

There is a system and a process for controlling the sending of information to subscribers comprising a plurality of steps. A first step can include receiving information to identify at least one information service. A next step can include inputting information for controlling the number of messages to be sent in the information service, including having the entity that initiates the information service setting a maximum number of messages that can be sent. Another step includes inputting information into the database to subscribe at least one subscriber to the information service. The next step includes transferring information to a server or a database for controlling the information service. Next, the information to be distributed is controlled based upon the information input into a controlling database. This information is controlled when it is relayed through for example, a central server. Next, messages can be continuously generated through the central server wherein these messages are distributed to the subscribers based upon the data entered into the controlling database. Furthermore, as an option, a change restriction on the maximum number of messages that can be sent by each information service can be set.

### CROSS REFERENCE TO RELATED APPLICATIONS

Applicant claims priority under 35 U.S.C. '119 from DE102005054160.7 filed on Nov. 14, 2005, DE102006006414.3 filed on Feb. 13, 2006, DE102006015246.8, filed on Apr. 1, 2006, DE102006022451.5 filed on May 13, 2006, DE102006031246.5, filed on Jul. 6, 2006, and DE102006044569.4, filed on Sep. 21, 2006, the disclosure of these patent applications are hereby incorporated herein by reference.

### BACKGROUND OF THE INVENTION

The invention relates to a process for controlling the sending of information to subscribers comprising a plurality of different steps. This system and process can be used to control information being sent through a central server which can be used to control the size or frequency of transmission of an information service. Other information service processes and systems are generally known in the art. For example, U.S. Pat. No. 6,826,534 to Gupta, U.S. Pat. No. 6,253,188 to Witek, U.S. Pat. No. 6,981,214 to Miller, U.S. Patent Application Publication No. 2003/0223089 to Laursen, U.S. Pat. No. 6,449,616, U.S. Pat. No. 6,741,980 to Langseth, U.S. Pat. No. 6,963,900 to Boyd, U.S. Pat. No. 6,766,362 to Miyasaka, U.S. Pat. No. 6,460,036 to Herz, U.S. Pat. No. 6,761,662 to Dasan, U.S. Pat. No. 6,990,633 to Miyasaka, U.S. Patent Application Publication No. 2005/0165743 to Bharat, U.S. Pat. No. 6,684,217 to Schneider, U.S. Patent Application Publication No. 2005/0049971 to Bettinger, Canadian Patent CA2297545 to Engel, U.S. Patent Application Publication No. 2004/0010508 to Fest et al. wherein the disclosures of all of these patents and published applications are hereby incorporated herein by reference.

### SUMMARY OF THE INVENTION

This invention generally relates to a process for providing an information service wherein an informer can send a message to a subscriber through a central information exchange which can be in the form of a central server or central database. With this case, an information service can be an offering unit where entities can subscribe to obtain information in the future in a particular information field. These informers and subscribers can be users which can use this service. Other users can include restrictors, initiators, and reviewers. For example, an informer is any person or entity who provides information to an information service. A subscriber is any person or entity who to subscribes to an information service. An initiator is any person or entity that initiates an information service. A restrictor is any person or entity that sets restrictions on, or controls information services. A reviewer is any user who reviews information provided by an informer for an information service. Any person or entity can assume multiple forms of the above roles of a user.

As stated above, an informer is an entity who provides information for at least one information service; this can be done by transferring information which can be in the form of messages to the central server or controller such as a central database. These messages can be in the form of a package or block of information which can be text, pictures, attachments or other types of information. The sending of this information can be in the form of a message or information being sent from a central controlling unit or controller such as a central information exchange in the form of a central server or a centralized controlling database which sends this message to a subscriber.

As stated above, a subscriber can be any entity who subscribes to an information service. In addition, all of these users can work with the central information exchange or central controlling unit that can be in the form of a central provider such as a central server or database that hosts the information exchange, that has features that make it possible to send information to subscribers.

The presence of this central information exchange makes it possible so that there is one central independent body that regulates the sending of messages to subscribers through for example a central server. With this design, the central information exchange can include a controller which may reside on a central server. The controller can be used in any way known in the art to control all aspects of this information exchange including but not limited to controlling the information service such as the size, frequency, time of day, or form in which the messages are sent. The controller can also control which types of information services are offered, and who can become an informer and a subscriber. As is known in the art, there are many different ways to manage the bulk information internally in this central information exchange. However the presentation of this information and the controlling features of this information have not been shown in the art.

For example, the invention can relate to a system and a process for controlling the sending of information to subscribers comprising a plurality of steps. A first step can include receiving information to identify at least one information service. A next step can include inputting information for controlling the number of messages that can be sent in the information service, including having the entity that initiates the information service setting a maximum number of messages that can be sent. A next step can include setting a change restriction on the maximum number of messages that can be sent by the information service. Another step includes inputting information into a database to subscribe at least one subscriber to the information service. Next, information can be transferred to a server or a database for controlling the information service. Thus, the information to be distributed can be controlled based upon the information input into a controlling database. This information is controlled when it is relayed through, for example, a central server. Next, messages can be continuously generated through the central server wherein these messages are distributed to the subscribers based upon the data entered into the controlling database.

This process can optionally further include a step of inputting information into the controlling database for at least one information service for controlling the amount of information sent through the information service. In this case, the amount of information can refer to length of messages, number of pictures, size of attached documents or other.

As stated above, the process can include the step of controlling the number of messages being sent wherein this step can include setting a maximum number of messages that can be sent per defined time period. This level of control can be based upon a monthly or yearly time period or other time periods, for instance per day, per week etc. This process can also include the steps of publishing the maximum number of messages that can be sent by an information service on a public website, and also publishing the maximum size of a message that can be sent on a public website. With all of the embodiments, the setup of an information service can be done by any entity with internet access unless on the blacklist of the central information exchange.

The process can also include the step of providing a link that leads to a subscription page to allow subscribers to subscribe to the information service. Or a link can be provided wherein when a potential subscriber clicks on the link, the potential subscriber is automatically subscribed in a manner such that no further steps are needed.

This process and/or system can also operate such least two information services are listed on a single, public website where subscribers can subscribe. In one embodiment, the information can be bundled such that at least one message being sent to at least one subscriber can include information relating to at least two information services. With one embodiment, there can be at least thirty informers that can be used to provide information for the central server concerning at least thirty information services.

This process can further comprise the step of defining who is eligible to provide information for the central server for at least one information service. This step of defining who is eligible to provide information can include selecting an individual informer. In addition or alternatively, this step of defining who is eligible to provide information can also include the step of allowing members from a particular group to provide information. In one embodiment, the step of defining who is eligible can include selecting from one of the following characteristics: informer's ratings, indemnification status of informer wherein with the indemnification status the informer agrees to pay a fine in case his information is objected or gets a negative rating.

This process can also optionally include a step of defining who is eligible to subscribe to an information service by the entity who initiates the information service. In this case, the definition of who is eligible to subscribe to an information service can be based on payments. In addition, or alternatively the definition of who is eligible to subscribe to an information service can be based on membership of a particular group.

This process or system can also be adapted to allow users to select how they would like to receive the messages. For example, this process can comprise the step of presenting subscribers with a choice of a delivery channel of at least one message from at least one information service. With this process, the transfer of information to the central server can be done by at least one of the following transmission modes: email, sms, mms, rss, or website. Alternatively, the system and process can also include the step of allowing subscribers to select a point in time when they will receive information from at least one information service. In addition, subscribers can also optionally select a time for sending a personal newspaper. It is also possible for a user to set a permanent message that cannot be changed by an informer.

It is also possible to set up an information service without defining who the informer will be, which makes it possible that informers can inform subscribers even though they did not know it beforehand that they will acquire this information. For example, with this system and process there can be a first step wherein information is input to a controlling database to identify an information service. Next, information can be input into the controller which can include a controlling database to define who is eligible to transfer information to the central server for at least one information service. This controlling information can include at least one of the following user characteristics: informer ratings; and informer indemnification status.

At any point during this process, subscribers can subscribe to an existing information service such that information about the subscriber is input into the controller or controlling database to subscribe the subscriber.

Once the information service has been established, information concerning the information service such as messages can be transferred to the controller. Next, the controller can control the information to be distributed based upon the information input into the controlling database. The final result is that the controller can continuously generate messages through the central server wherein these messages are then distributed to these subscribers based upon data entered into the controller.

With this system or process, there can be a ratings system wherein subscribers can rate the information service provided by at least one informer. With this ratings service, the ratings can lead to a punishment for one or more of the informers of an information service.

This system and process can also be used to control the number of messages being sent and also be used to bundle information relating to two or more information services.

In another embodiment, there can be a system or process that can be used for inputting information into the controller to set up a value account for at least one informer. With this embodiment, when the informer provides information for at least one information service, the account value of at least one informer can be raised. In this way, informers can be rewarded for contributing information.

The way that the account is raised can directly depend upon the cost of the information service or messages to the subscriber. Or the extent to which the account is raised directly depends upon advertising revenues raised by the messages. Money payments can also be made to the respective informers wherein the account value is then correspondingly reduced.

In another embodiment, there can be a system or process wherein the messages to be sent have to be confirmed by at least two informers or reviewers before the messages are sent. In this case, one of the additional steps can include the confirmation of the transferred information by at least two informers or reviewers other than the informer who provided the initial information. Thus, at least three informers have agreed on a message in for a message to be sent. For example these confirmations can be limited to only those selected entities who are members of a particular group.

With this embodiment, the controller can choose which entities should be actively asked to confirm the information. The selection of the confirming entities can be based on the rating of the entity, the date of the last request to confirm other transfer information, the number of subscribed information services, and the date of the subscription. In one embodiment, the sending of the confirmed message to subscribers depends on at least one of the following features: either a certain number of confirmations required, or the number of confirmations that are required in a particular time period.

In another embodiment users such as an initiator can define that information provided for an information service has to follow certain structures or formats or has certain tagged values. Subscribers can then customize information services concerning when or what information will be sent based on the structure of the information service or tagged values. For example, a subscriber subscribing to an information service based on professional tennis can input information such that every time a US tennis player wins a quarterfinal or greater round of the tournament he will receive the players names of the quarterfinal, the name of the tournament, and the round of the result.

Thus, with all the above embodiments, the sending and receiving of information can be controlled between different entities such that subscribers in particular, are not inundated with unnecessary information. The resulting higher number of subscribers is beneficial for informers because they can inform more entities. In addition, with this system and process, informers can be rewarded for providing or sending of this information. The mechanisms disclosed also reduce the risk that wrong messages get sent to subscribers. The possibility to customize information services makes it possible that informers provide information only once and it gets automatically customized by the controller and sent to the subscribers.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, wherein similar reference characters denote similar elements throughout the several views:

FIG. 1A is a flow chart showing an example of multiple embodiments of the process for providing and subscribing information services;

FIG. 1B is a block diagram of the system for providing the process shown in the flow chart of FIG. 1A;

FIG. 2A discloses a screen for allowing a user to input information into a controller such as a controlling database about an information service.

FIG. 2B discloses a table listing the different information services which can be registered in the controlling database

FIG. 2C discloses an example of the channel for setting up an information service

FIG. 3A discloses a screen for allowing a user to control the number of messages or limit the number of messages that are to be sent with the information service.

FIG. 3B discloses a screen for allowing users to manage their account at the central information exchange and manage information services such as offered information services.

FIG. 4, discloses a screen which can be used to allow a user such as an initiator of information services to restrict the amount of information in the messages

FIG. 5A discloses a screen allowing a user such as a subscriber to decide how messages from a specific information service should be delivered

FIG. 5B discloses another screen wherein this screen allows a user to select from a pulldown bar such that the user can select the delivery time and delivery channel of that type of newspaper

FIG. 6A discloses a diagram showing the rights that a subscriber would give to an informer or an information service

FIG. 6B, there is a screenshot of the screen allowing the user to define which sent messages of an information service should be public.

FIG. 7 for defining who is eligible to provide information for an information service.

FIG. 8A discloses a form screen which prompts the user via a heading to select who can subscribe.

FIG. 8B shows a screen indicating how many informers or controllers have confirmed a particular message and whether any of the controllers indicate whether the message is wrong.

FIG. 9A discloses a screen 450 which includes a search block which allows a user to search for a particular information service.

FIG. 9B discloses a web screen which reveals an email with information sent to a subscriber;

FIG. 9C shows a screen view of this information delivered via sms or a text message, which includes a header line, and an information line;

FIG. 10A discloses an information screen to inform a subscriber of his subscriptions;

FIG. 10B discloses an information screen to inform an informer of the offered information services;

FIG. 11A shows a screen providing an option for a user such as an initiator of an information service to define tagging values or categories for provided information or messages of an information service;

FIG. 11B shows a screen providing an option for a user such as an initiator of an information service to define the structure of provided information or messages of an information service by selecting predefined formats;

FIG. 11C shows a sample screenshot of the controlling database which lists provided information for one message of an information service in a defined structure;

FIG. 12A is a screen allowing a subscriber to select the time period of delivery based on the defined structure of the messages of the information service;

FIG. 12B is a sample screen providing a user such as an initiator of an information service to define the structure and format of provided information or messages of an information service; and

FIG. 12C is a sample screen allowing a subscriber to determine when information and what information should be sent through the information service based on the defined structure.

### DETAILED DESCRIPTION OF PREFERRED EMBODIMENTS

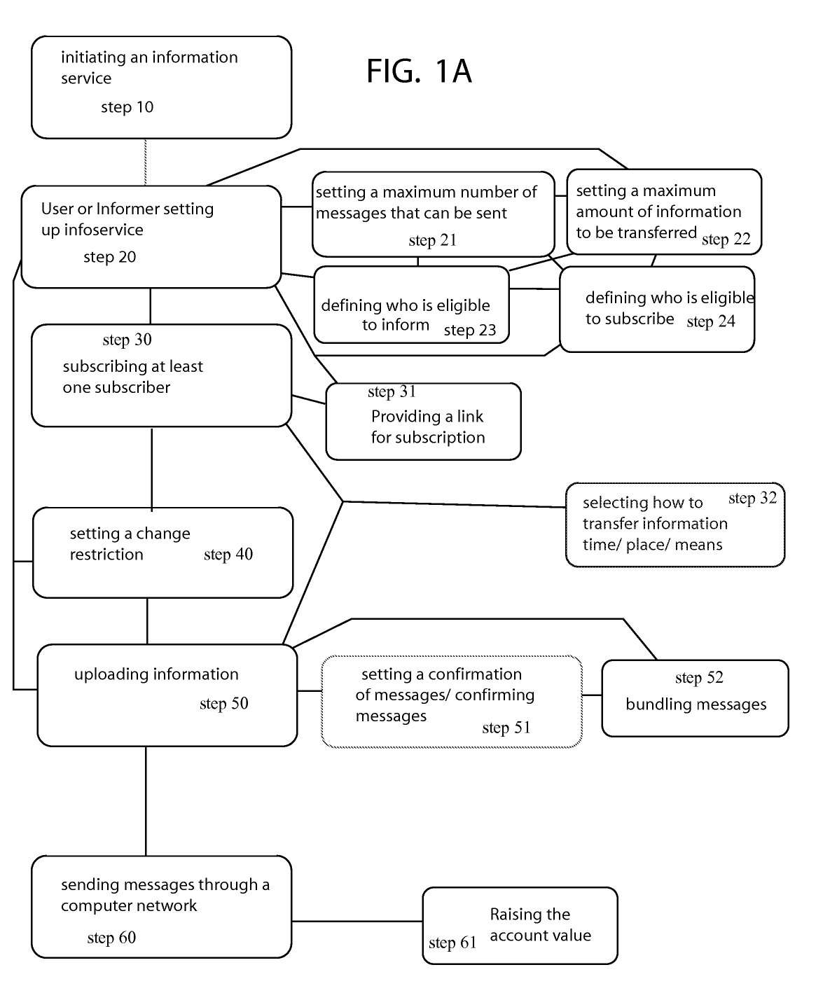

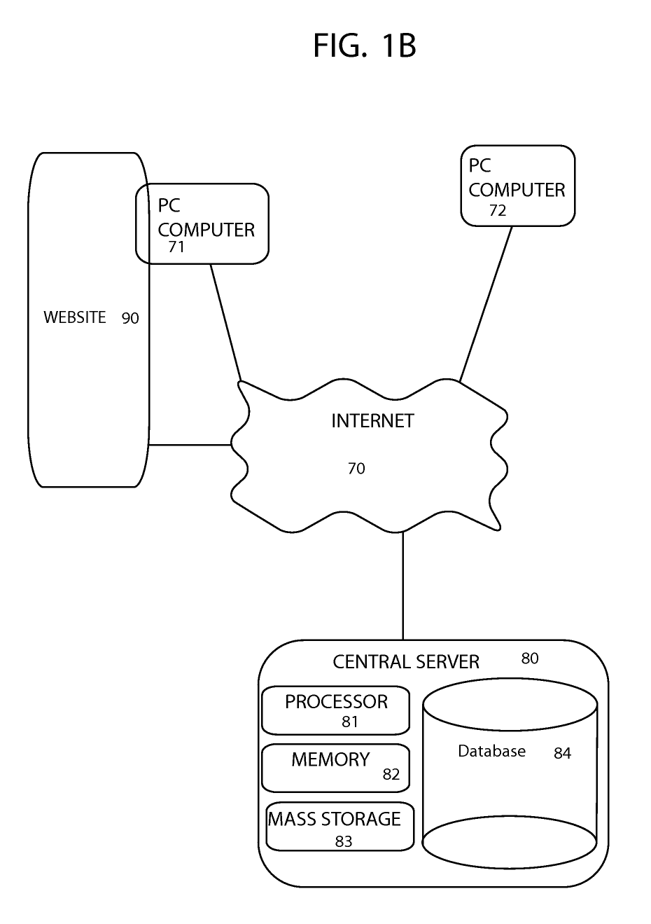

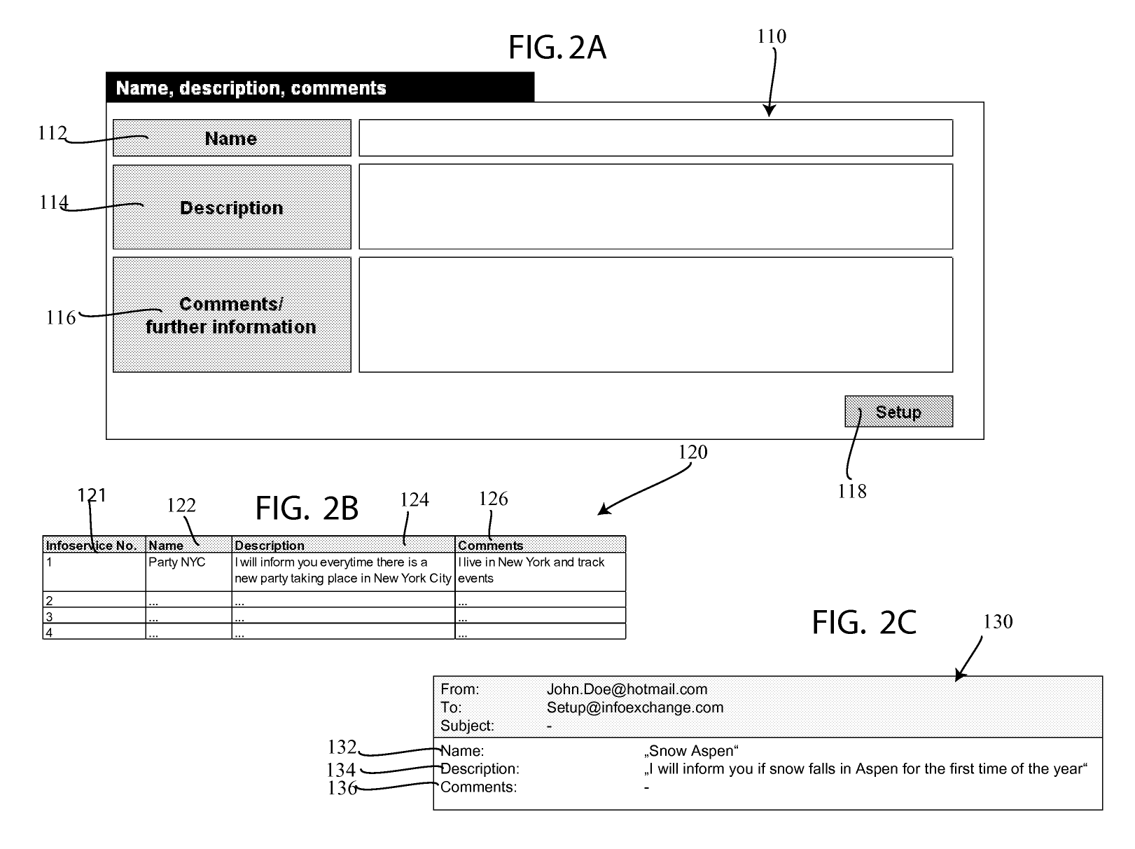

FIG. 1A discloses a flow chart, which discloses a series of steps for completing the process, according to the invention. For example, step 10 can include initiating an information service. The step can include inputting information into at least one controlling database 84 (See FIG. 1B) to identify at least one information service. Other means for initiating an information service without using a central database may be used as well. For example, in this step, an informer or other type of user would set up a new information service through the Internet 70. This can be shown in FIG. 1B, which discloses the internet 70 which can be connected to a series of personal computers 71 and 72. These personal computers 71 and 72 can be used for allowing a user to connect through the internet to central server 80. For example, once an initiator or informer logs on to the central server 80 that person can then in put information into central database 84 through a web page shown in FIG. 2A.

As shown in FIG. 1B, central server 80 can include a processor 81 for running a controlling program, a memory 82 which can act as a RAM or read only memory, a mass storage which can include a hard drive which can include programs or data stored therein. This information including programs or data can also be stored on other servers or on other computers which can be accessed through internet 70. For example, a controlling program or controller can be run on processor 81, reside in memory 82, and be retrieved from mass storage 83. Other known ways for running a controlling program on central server can be implemented as well. In addition, in one example, a controlling database 84, which can actually be in the form of one or more databases having one or more tables can be either stored in central server 80 or stored on any computer or medium which is accessible by central server 80. This controlling program can then be used to selectively access the necessary information that may be contained in database 84 to complete particular tasks.

Central server 80 can be used to assist a user in initiating the information service. As a result, the new information service is saved in the controlling database 84 and a print out or display of this database is shown by way of example in FIG. 2B. The set up of the information service can obviously be completed directly on a web site 90, which can be shown by way of example on computers on the Internet 70, on central server 80, as well as personal computers 71 and 72. However, it is also possible to complete this through other known channels such as via e-mail, text messaging or other known communication means. An example of an e-mail that can be used to complete this step is shown in FIG. 2C. This step also includes the process of having a controller such as a controlling database check or clear whether an information service is being set up. For example, the controller can limit the types of information conveyed in an information service. In addition, the controller can limit or control who can set up an information service. This can be based upon the previous record or history of an informer or information service provider.

Once the information service has been initiated, in step 20, a user such as an initiator can set up an information service. For example, in one step, the user such as an initiator in step 21 can set the maximum number of messages that can be sent. Other optional steps extending from this basic step can include setting a maximum amount of information to be transferred in step 22 and also limiting, who is eligible to provide information in step 23. Another optional step, step 24 can include defining who is eligible to subscribe. Steps 23 and 24 can occur in any order and are both optional as well.

Next, users such as subscribers can subscribe to this information service. To create a subscription, an optional feature in step 31 is to provide a link to a web site for a subscription then a user clicks a link to that website to subscribe or to subscribe automatically to that information service. An automatic subscription includes only one mouse click in order to be subscribed, for example if the user is already logged in at the central information exchange. To select how the information is to be delivered to the subscriber, another optional step 32, can involve having the subscriber select how the information is delivered. The selection can be used to select the time, the place, and the means for the delivery of information.

Next in step 40, this step can include setting a change restriction, which can be used to restrict any changes of an information service. For example, the change restriction can concern the defined maximum number of messages that can be sent through an information service which has been defined during the setup of the information service so that users cannot change the maximum number of messages that can be sent through an information service. Setting of the change restriction can be performed by a restrictor or controller, such as controlling database 84. This change restriction can occur at any step in the process after the maximum number of messages that can be sent of an information service has been set. In one embodiment, this change restriction is performed automatically, i.e. no manual steps are required. In another embodiment, the change restriction can occur manually wherein users such as subscribers can vote on the number of messages or the amount of information that can be transferred in setting a change restriction. Once a predetermined number of users have voted, this change restriction is set. This means for voting can occur for example, on line via a webpage, via email or via any other known means for transferring information. In another embodiment users such as subscribers or informers can elect representatives or officials to manually set the change restriction governing the number of messages or amount of information that can be transferred by an information service.

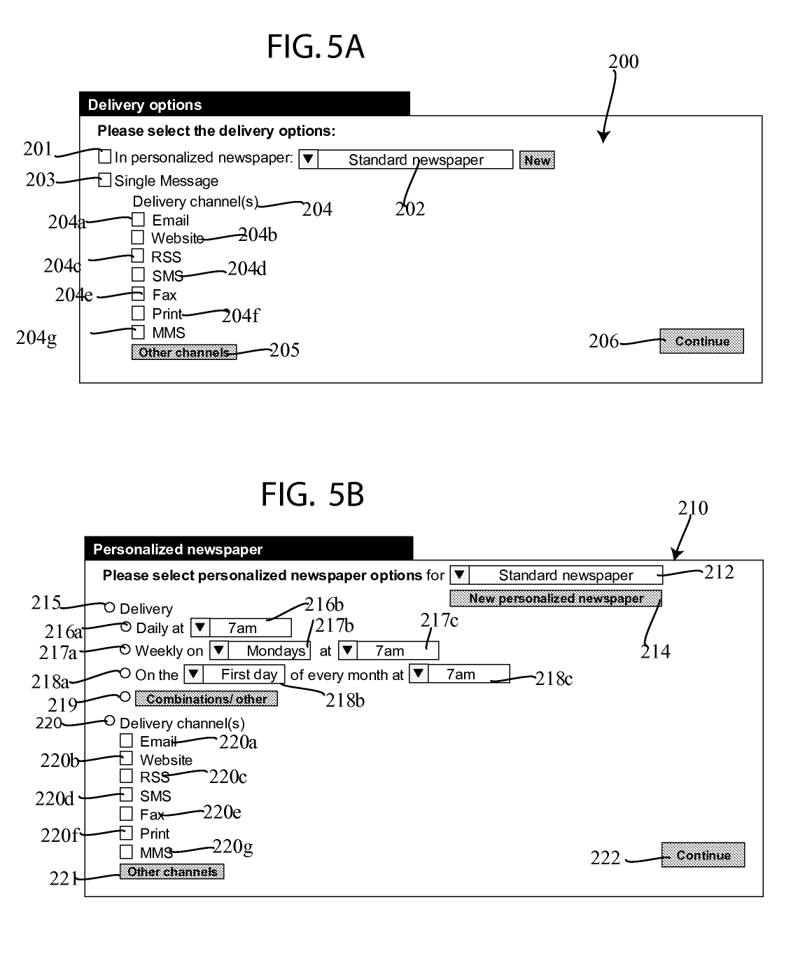

The next step, step 50 includes uploading or transferring information to be sent through an information service to a central server 80 or into a central database 84. Associated with this step can be optional steps including step 51, which includes setting a confirmation of information confirming the receipt of this provided information. The uploading or transferring of this information can occur in any known manner. In addition, associated with the uploading or transferring this information, can also be an optional step, including step 52 which includes bundling information from several information services. The bundling of this information is such that a user can select different delivery options via a prompt screen shown in FIG. 5A for a set of information from several information services where a user selects a personalized newspaper. The subscriber can decide how often his personalized newspaper is sent as shown in FIG. 5B.

Next, in step 60 these messages or personal newspapers can be sent through a computer network. In this way either the messages can be sent including the full text of the uploaded information of the information service(s), or a link can be sent allowing the user to reveal a web page disclose in a personal newspaper. If only a link is sent, then a user's selecting this link would have the personal newspaper revealed to him or her. Once these messages are sent, there can be an ongoing tally for setting an account value for users such as for example informers. These informers may have an online account which may be raised or lowered based upon the contributed information.

FIG. 2A discloses a screen 110 for allowing a user such as an initiator to input information into a controller such as a controlling database about an information service. This screen 110 can include a prompt 112 for allowing the user to input the name of the information service, there is also a field 114 to input a description of the information service as well as a field 116 to input additional comments about the information service. When the user then sets up the information service, this new information service is then registered in a controlling database which can have a table that is shown by way of example in example FIG. 2B.

FIG. 2B discloses a table listing the different information services which can be registered in the controlling database. For example this table 120 can include a first heading 121 listing an information service number, a second heading 122 listing information service name, a third heading 124 listing the description of information service and a fourth field 126 listing the comments regarding the information service. These fields can be listed to correspond to the input fields shown in FIG. 2A.

FIG. 2C discloses an example of the channel for setting up an information service. For example FIG. 2C discloses a portion of an email which can be used to help set up an information service. This email can include a listing of the name, the description, and the comments for that information service. Alternatively, an information service can be set up through web site, through text messaging, by filling out a form and mailing that form into a central mailing address, or any other known communication means. When the information is transferred to the central server, it is then input into the controlling database.

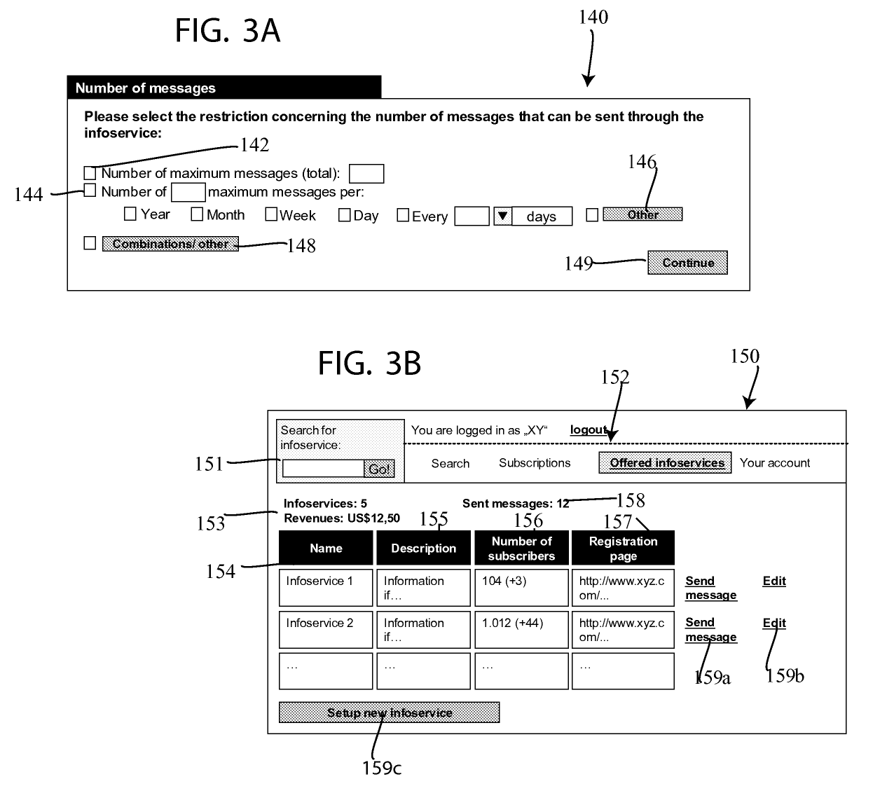

FIG. 3A discloses a screen for allowing a user to control the number of messages or limit the number of messages that can be sent with the information service. For example, this screen 140 includes a first field 142 allowing the user to limit the maximum number of messages allowed. There is also a second field 144 allowing the user to control the maximum number of messages per time period, such as per year, per month, per week, per day, or per every specified number of days or other time period. There is also an additional field 146 which allows a user to set another type of sending restriction that can be a customized sending restriction. There is also a field 148 which allows the user to check different combinations of sending, including combinations of limits for sending messages. Finally, there is also a button 149 to allow a user to continue to additional screens to import in additional information for that information service.

FIG. 3B discloses a screen for allowing users to manage their account at the central information exchange and manage information services such as subscriptions to information services or offered information services. For example, this screen 150 includes a prompt 151 allowing user to search for information services. In addition, there is also a control bar 152 which can be used to allow users to scan the list of subscriptions, manage different offered information services, or to allow the user to review his or her account. In this view, a listing of offered information services is selected wherein this listing discloses columns which relate to 155 the description 156, the number of subscribers 157, and the associated registration page 150. In addition, the screen also lists information relating to the number of information services listed, the revenues generated from these information services. There's also a field indicating the number of sent messages 158. In addition, on this page are also hyperlinks allowing any user to click on, such that there is a first hyperlink 159a allowing user to send a message at least one second hyperlink 159b allowing user to edit a particular information service, and a button 159c allowing users to set up a new information service.

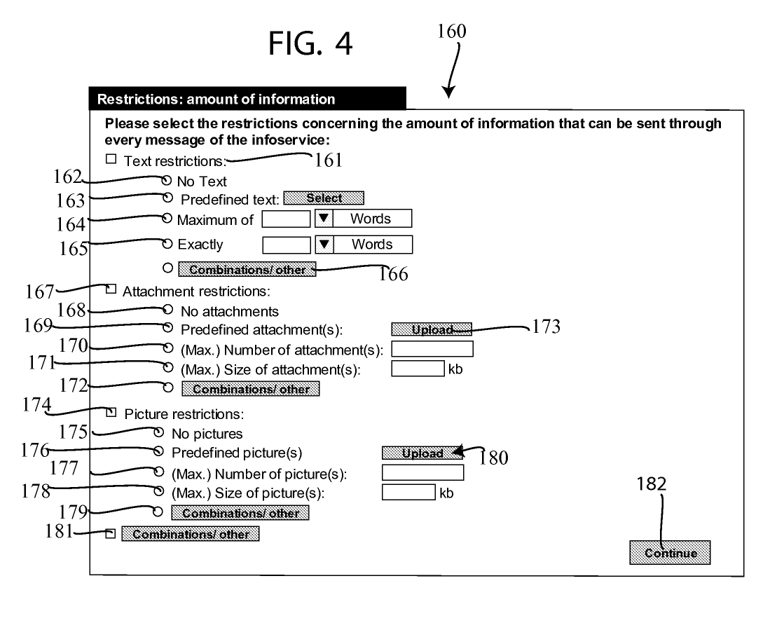

In addition, a user can also limit the amount of information that can be sent through any particular information service. For example, FIG. 4, discloses a screen 160 which can be used to allow a user such as an initiator of information services to restrict the sending of messages in the form of text, attachments, or pictures. For example, there can be a prompt 161 allowing a user to check whether there is a restriction on text. If a user selects text restrictions the user can check either a prompt 162 for no text a prompt for predefined text 163 or a prompt for the maximum number of words 164, a prompt for exactly the number of words 165, or a prompt selecting combinations of the above restrictions 166. Alternatively, or in addition the user can also select whether to restrict attachments. Therefore, there is a prompt for restricting attachments 167 which includes the prompt of restricting no attachments 168 or a prompt for predefined attachments 169, a prompt for the maximum number of attachments 170, a prompt for the maximum size of the attachments 171, or a prompt for allowing combinations of types of attachments 172.

Alternatively, or in addition, there can also be a prompt for restricting pictures 174, this can include some prompts restricting the sending of information to no pictures 175, a prompt for restricting predefined pictures 176, a prompt for restricting the maximum number pictures that can be sent 177, a prompt for restricting the size of the pictures 178, or a prompt for allowing for the combination of different features disclosed above 179.

Under this heading, there can also be a section 180 allowing a user to upload a file selected from a directory. In this case, once the user has uploaded the file, this information will be sent in the form of a message if this message is sent to subscribers. In addition, there is also a field 181 allowing the user to select different combinations of different types of restrictions listed above for the entire different sets of restrictions. Therefore, a user can restrict the information service based on multiple different permutations including no text restrictions, partial text restrictions, all text restrictions, no attachment restrictions, partial attachment restrictions, or all attachment restrictions, no picture restrictions, partial picture restrictions, or all picture restrictions.

FIG. 5A discloses a screen 200 allowing a user such as a subscriber to decide how messages from a specific information service should be delivered. For example, the user can select whether to receive this information in the form of personalized newspaper via a prompt 201. This prompt allows a user to select in which of his newspapers messages of the information service should be delivered. There is also a prompt to allow a user to select whether to deliver the messages in the form of single messages via a single message prompt 203. Typically, the option “single messages” delivers the messages immediately while in the “personalized newspaper”-option messages get accumulated and sent to the subscriber in a bundled way at a selected point in time. Other subsets of this selection can include a plurality of delivery channels 204. For example, these delivery channels can include an e mail delivery channel tool for a prompt for an email delivery channel 204a, a prompt for a web site delivery 204b, a prompt for a RSS delivery 204c, a prompt for a SMS delivery 204d, a prompt for a fax delivery 204e prompt for a print delivery 204f, a prompt for a MMS delivery 204g. In addition there can also be a button 205 to allow user to select other channels. There can also be a button 206 to allow a user to continue onto an additional screens such as the screen shown in FIG. 5B.

FIG. 5B discloses another screen 210 wherein this screen allows a user to select from a pulldown bar 212 such that the user can select the delivery time and delivery channel of that type of newspaper. Alternatively, there is a button 214 to allow a user to select a new personalized newspaper. In this screen 210, the user can select the time of delivery via a prompt 215. Subsets of this prompt can include a prompt to select the delivery time daily 216a and via a pull down bar at a particular time 216b. In addition the user can select via a prompt 217a to determine whether to deliver the newspaper weekly, such as on a particular day of the week, via pull down bar 217b and at a particular time via pulldown bar 217c. Alternatively, the user can select whether to deliver the newspaper online basis such as for example via a prompt 218a which can be used to select the monthly basis, and also the day of the month be a pulldown bar 218b. Once the day is selected, the user can also select the time of day that the newspaper is delivered via pulldown bar 218c. There can also be a prompt 219 with a button which allows the user to select different combinations of delivery times from the assorted delivery times shown above.

Once the user selects this type of selection, he can choose the type of delivery channel. For example, the user can select among the following different types of delivery channels email 220a, web site 220b, RSS 220c, SMS 220d, fax 220e, print 220f, MMS 220g. In addition, the user can select via a selection bar button 221 for other channels for delivery. Once the selection has taken place or has occurred, the user can select button 222 to continue with the selection process.

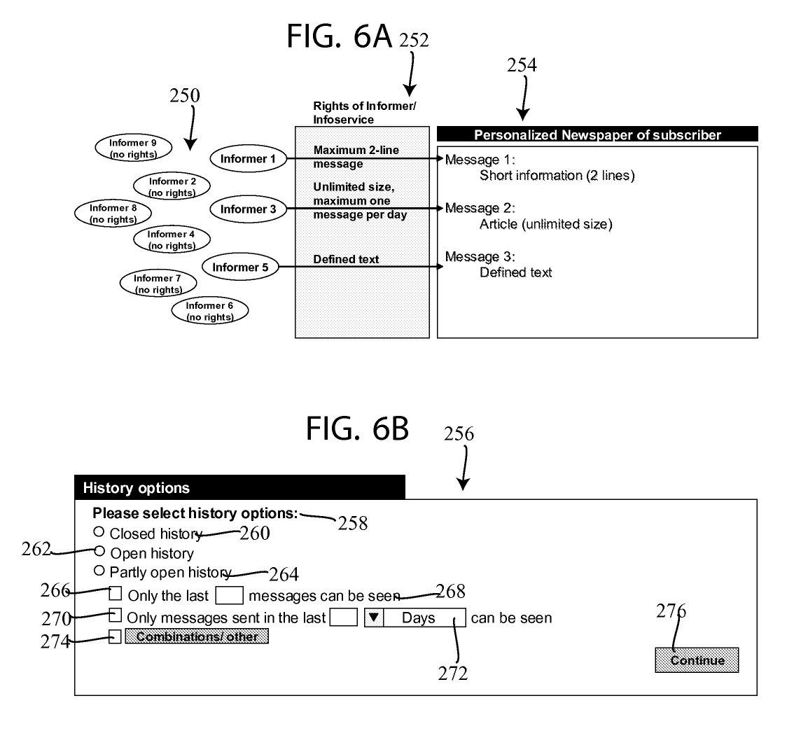

FIG. 6A discloses a diagram showing the rights that a subscriber would give to an informer or an information service. For example, in the diagram shown in FIG. 6A, there is shown a series of different informers from informer 1 through informer 9 in a generalized informer field 250. In this example, the subscriber is subscribed to three information services with each of the information services having different rights concerning the maximum number of messages and maximum amount of information per message as shown in field 252. For example, an informer under information service 1 has the right to send only a text message with a maximum of two lines of text. An informer under information service 2 has the right to send only a maximum of one message a day, however this is with no limitations concerning the size of the message. In this example, when subscribing to the information services shown in FIG. 6A the subscriber has opted for a newspaper delivery shown in FIG. 5A. In this example all of the three information services have sent a message during a certain time period and therefore the messages got accumulated and bundled in one message, i.e. the personalized newspaper of the subscriber, and delivered to the subscriber as shown in field 254.

This process can also include defining if messages in an information service should be public to users after these messages have been sent through the information service. For example, as shown in FIG. 6B, there is a screenshot of the screen allowing the user such as an initiator to define which sent messages of an information service should be public. This screen 256 includes a prompt for a user such as an initiator of an information service to select the history options 258 which can include selecting a prompt for a closed history 260, a prompt for open history 262, a prompt for a partly open history 264, a prompt for only the last messages that can be seen in checkbox 266 and fill-in blank 268, a prompt selecting only the message that was sent in last in a particular set of days 272, or a prompt 274 allowing users to select combinations of the above selections. Once this user selects this information, the user can select a button 276 to continue with these questions.

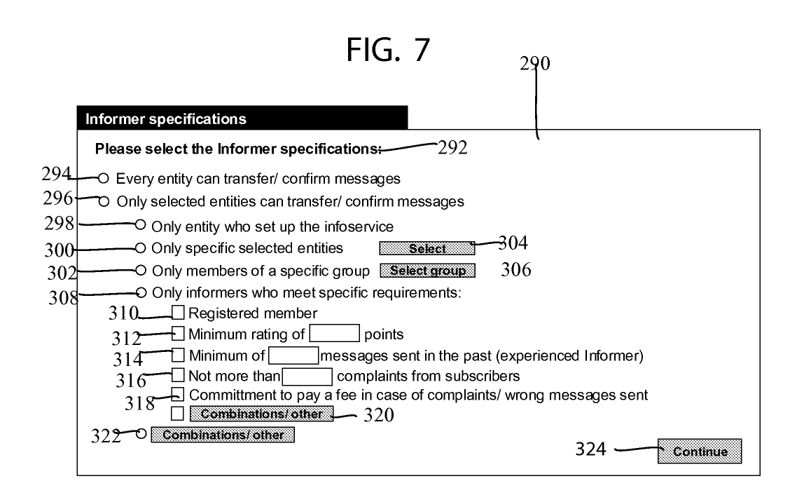

This process can also include a screen as shown in FIG. 7 for defining who is eligible to provide information for an information service. For example, this screen 290 includes a prompt or heading 292 to indicate that the informer needs to complete a series of options. For example, there is a prompt or a radio button 294 that allows anybody to provide information (no restrictions). In addition there's a radio button or prompt 296 which indicates that only selected entities can transfer or confirm messages. There is a radio button 298 which indicates that only the entity who set up the information service can provide information. There is also a radio button 300 which indicates that only specific selected entities can provide information and a button 304 which is used to open up a screen listing all of the potential selected entities. There is also a radio button or prompt 302 which allows the informer to select only members of a specific group this includes a button for allowing the user or informer to select particular groups. There is also a radio button 308 which selects which limits only informers who meet specific requirements. These requirements can be: whether the informer is a registered member as indicated by checkbox 310, whether the informer has a minimum rating of a selected number points as indicated by checkbox 312, whether the informer has a minimum number of messages sent in the past showing experience as indicated by checkbox 314, whether the informer has not more than a select number of complaints from subscribers as indicated by checkbox 316, whether the informer has made a commitment to pay a fee in case of complaints or wrong messages sent as indicated by checkbox 318. In addition, there is also a checkbox 320 which allows for combinations of any of the above criteria. Furthermore, there can also be a radio button 322 for the selection of the combination of any of the above selected criteria to be used in selecting particular criteria for informers. This screen also includes the continue button 324 allowing the user to continue on to additional screens.

Examples of these limitations can be such that when informer is registering at the central information exchange, this system may require that people provide information on where they live such as New York City or Chicago to set up an information service relating to New York City such as “Party NYC”. Because this service is related to New York City, a limitation could be used so that this would define only people that live in New York City. Therefore, the system could limit who could be an informer such as only those who live in New York City. In another example, similar to the one above, if the user wanted to set up an information service such as party New York City that information service could be limited to only those who are members of another online group such as party freaks New York City. Thus, only people of that type of group could provide information for this information service. Alternatively, the informers could be limited to only those who have a sufficiently high rating wherein this rating can be supplied by subscribers. This limitation could also include whether the informer has agreed to indemnify, i.e. committed himself to pay a fee if messages are proven to be wrong or of poor quality as rated by subscribers.

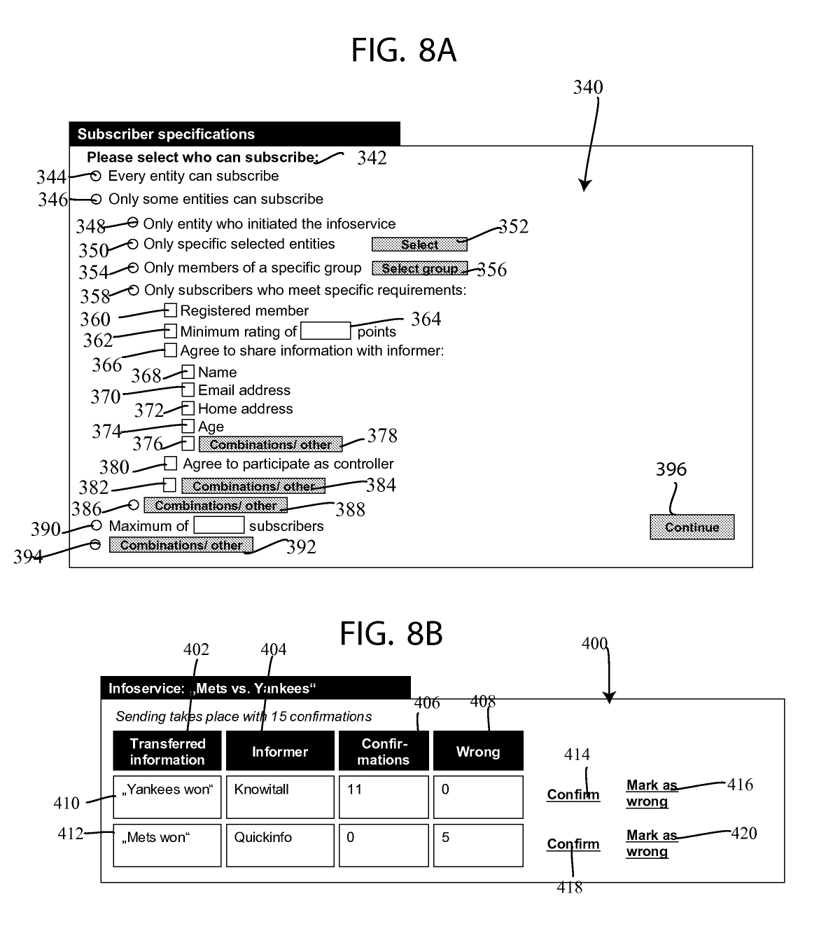

Another feature of the present invention is that it can be used to define who is eligible to subscribe to an information service. Typically this selection process is done by the entity who initiates the information service. For example the entity who initiates information service can be asked to fill out the form shown in FIG. 8A.

FIG. 8A discloses a form screen 340 which prompts the user via a heading 342 to select who can subscribe. For example, there is a radio button 344 allowing the user to select every entity can subscribe. In addition, there is another radio button 346 which is more limited, which allows only some entities to subscribe. Under this heading, there are a plurality of radio buttons and check boxes which further limit who can subscribe. For example there is a radio button 348 which limits the subscription to only the entity who initiated the information service. There is another radio button 350 which allows the user to select which particular entities can subscribe via a button 352. There is also a radio button 354 which limits the selection to only members of a specific group and provides a button 356 for selecting that group. The selection process can provide a listing of a separate web page or a partial web page of these types of groups. In this view the user can for example, highlight these groups and select a radio button 358 which can be selected such that only subscribers who meet particular requirements such as whether the subscribers are a registered member 360 or whether they have a minimum rating of a particular set of points 362, or whether they agree to share information with informer 366. This is shown by checkboxes 362, 364, and 366. For checkbox 362, there is a prompt or button box 364 allowing the user to input the minimum number of rating points for the selection. In addition, the informer can require that the subscriber provides his or her name or an email address, home address, or age either individually, or on an aggregated level via checkboxes 368, 370, 372 and 374.

In addition, users can also select any combination of these requirements with checkbox 376 and button 378. Furthermore, there can be a checkbox 380 which requires that subscribers agree to participate as a reviewer. A reviewer is someone who is willing to monitor the information being presented as part of the information service. These reviewers can then confirm or object to the provided information which leads to the information being sent to the rest of subscribers or not sent to the rest of the subscribers. There are also checkboxes and buttons allowing the user to select different combinations such as checkboxes and buttons 382, 384, 386, and 388. There are also buttons 390 allowing the user to limit the number of subscribers, as well as additional checkboxes or buttons 392 and 394 allowing for different combinations to be selected.

As stated above, this central information exchange can be a public place where every party can participate. Thus the exchange of information, especially news, can take place at a central provider or web site. For example, FIG. 8B shows a screen indicating how many informers or reviewers have confirmed a particular message and whether any of the reviewers indicate whether the message is wrong. In this example, the sending of this information takes place after there are 15 confirmations of this message. Thus, the sending of information can be limited to only sending this information after at least a particular number of reviewers has confirmed a particular message.

Another type of limitation that can be used is that this system can be limited such that only subscribers who are willing to pay a fee may subscribe. Furthermore, there can be a radio button 386 which can be used in conjunction with button 388 to allow for combinations of the above cited limitations. There is also a radio button 390 which limits the maximum number of subscribers and a radio button 394 which works in conjunction with button 392 for allowing for a full field combination of all of the limitations or restrictions. Once the user has completed this form, user can select continue button 396 to continue on to another web page.

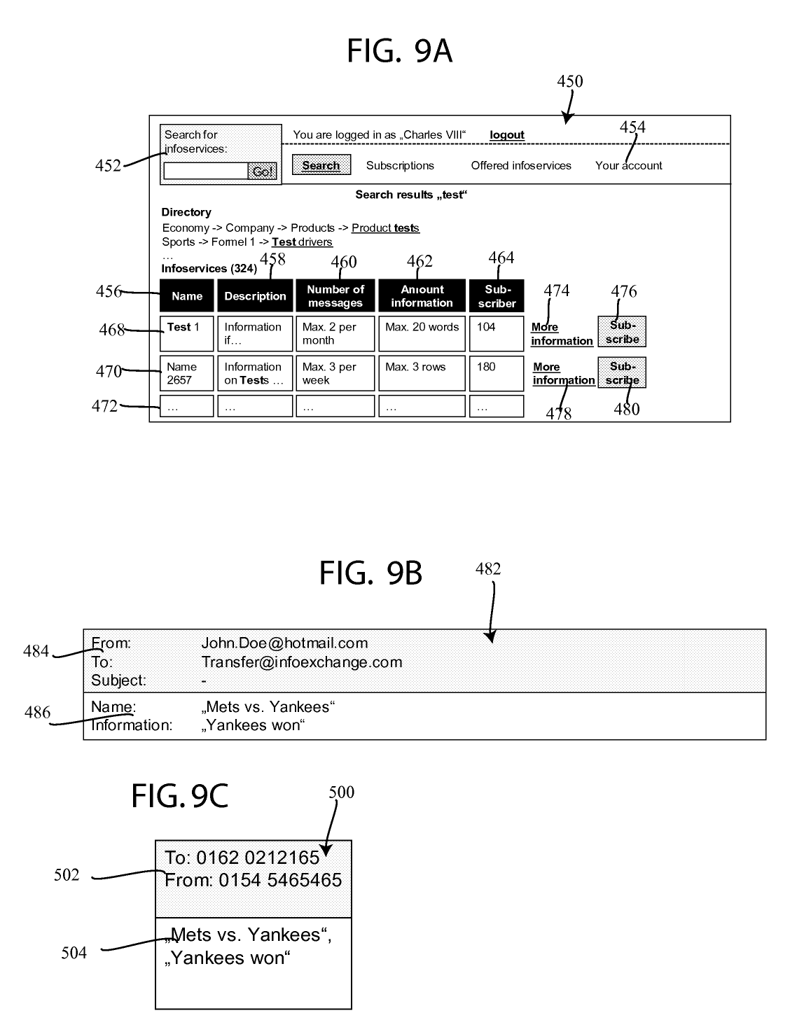

Information relating to these information services can be shared on a public website. For example, FIG. 9A discloses a screen 450 which includes a search block 452 which allows a user to search for a particular information service. There is also a row 454 which includes options for the user to search, enter or enroll in subscriptions, review offered information services, or to allow a user to review his or her account.

This web page includes a row of headings identifying each information service. For example, there is a heading for name 456, a heading for description 458, a heading for the number of messages 460, a heading for the amount of information 462, and a heading for a subscriber 464. Under each of these headings are rows of information services such as rows 468, 470 and 472. Each of these rows have links allowing the user to request more information about the information service or to subscribe to the information service such as shown with links 474, 476, 478, and 480.

Once this information has been uploaded and subscribed to by a subscriber, then this information can be transferred to a user such as a subscriber. For example, FIG. 9B discloses a web screen which reveals an email 482, which has a header section 484 including information on who is sending the information, who is receiving the information and the subject as shown in header 486, and an information section 486 which includes the information being sent to the subscriber. Alternatively, this information can be sent via a SMS or text message as shown in FIG. 9C. FIG. 9C shows a screen view of this text message 500, which includes a header line 502, and an information line 504.

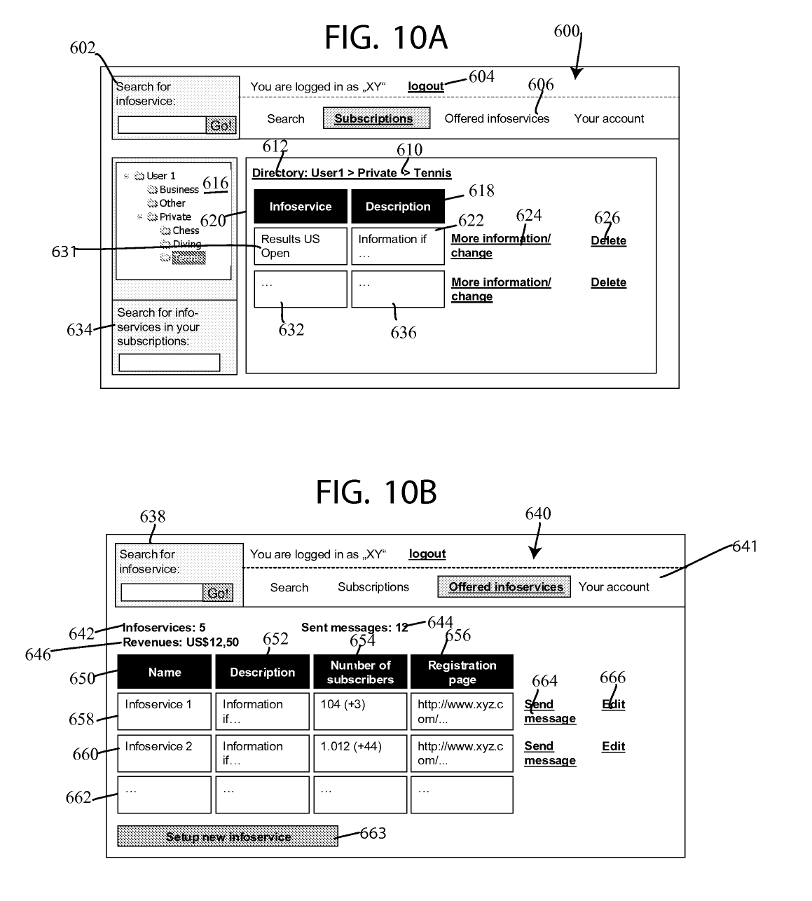

This system and process can also include information screens to inform the different users such as informers and subscribers of their subscriptions or offerings. For example, FIG. 10A discloses a screen 600 which includes a search block 602, which can be used to allow a user such as a subscriber to search for information services. There is a row 606 which is similar to row 454 which is used to allow a user to review different types of information such as search results, subscriptions, offered infoservices, and account information. In this case, the subscriptions link has been selected which results in the presentation of a directory 616 for selecting different information services. With this view there are headings including a list of the infoservice 620, and a list of the description 618. There are also at least two rows including rows 631, and 632. These rows are the return results for a subscriber listing his or her subscriptions. Adjacent to these rows are links 624 and 626 allowing a user to get more information about an information service, to change the selections for the information service, such as the delivery channel of messages, or to delete or unsubscribe from the information service. There is also a search block 634 allowing a user to search for information services in particular subscriptions. This provides for the user a more refined search of these information services.

FIG. 10B discloses a screen 640 which is used to list the types of information services that an informer can provide. For example, there is shown a search block 638 which allows a user such as an informer to search through the different information services. Selection row 641 which is similar to selection row 606 includes a series of selection links wherein in this view selection line “offered infoservices” has been selected. Consequently there is shown a readout of these different information services below this selection row.

For example, this webpage 640 discloses the number of information services offered, 642, the number of sent messages 644, and the amount of revenues available for a user 646 such as an informer. In this case, informers can be penalized for sending incorrect or improper messages, therefore this account can be debited after subscribers notify a controller that messages have been incurred or if these messages are improper. Other ways to penalize informers would be to change their ratings or rankings, or changing their permissions. There are also a series of headings for columns listing information services, including name 650, description 652, number of subscribers 654, and a listing of the registration page 656. This review or listing includes a plurality of columns 658, 660, and 662 which list each information service associated with a particular informer. There are also selection links 664, and 666 which allow a user such as an informer to send information such as a message, or to edit the information service.

Another feature of the present invention is that users such as an initiator can define that information provided for an information service has to follow certain structures or formats or has certain tagged values. Subscribers can then customize information services concerning when or what information will be sent based on the structure of the information service or tagged values.

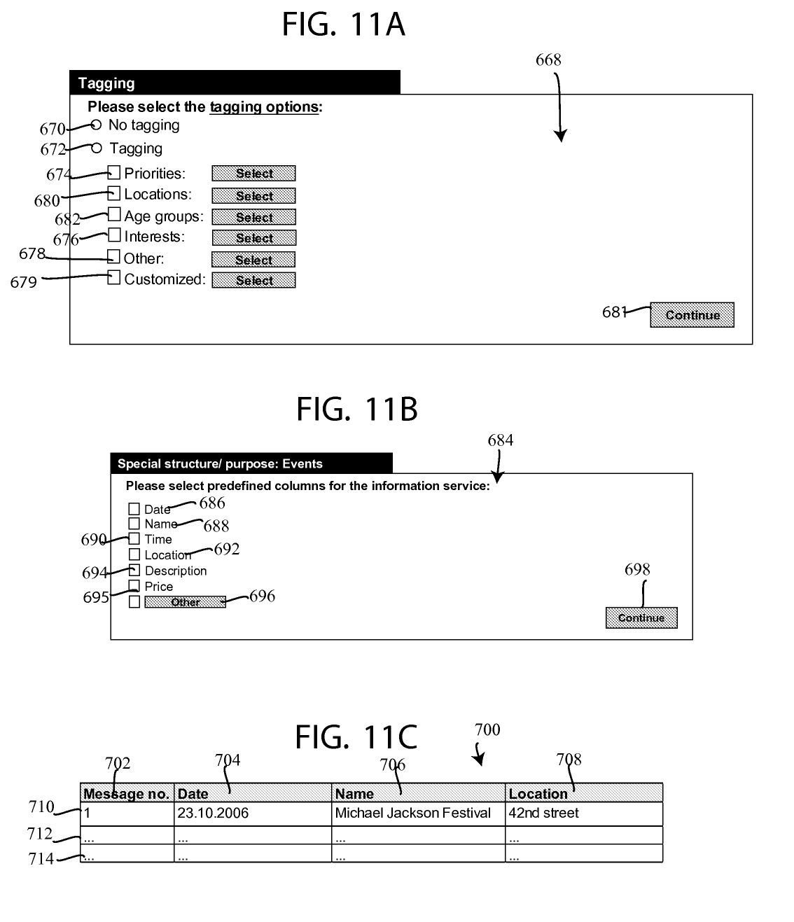

For example, as shown in FIG. 11A, a user such as an initiator can define on screen 668 that messages or provided information for an information service must have certain tagged information. On screen 668 several tagging options are presented. For example, the initiator of the information service can define the information service to have no tagged information via radio button 670. There is also another radio button 672 which allows a user to define tagging values. For instance, he may define with radio button 674 that messages or information provided for the information service must have a priority. Subscribers can then define when subscribing that they will receive only messages with certain priorities. Other tagging options can include (but are not limited to), locations 680, age groups 682, interests 676, other 678 or customized values 679. There are also buttons associated with each of these checkboxes allowing the user to select among a varied list of different selections.

This tagged information is not part of the information service or messages itself, rather the main aim is to give subscribers the chance to only receive messages with certain tagged values.

For example, a user may initiate an information service “Party NYC” and defines as a tagging class “music style” with the possible values “jazz”, “classical music” and “pop”. Every message that gets transferred to the controller such as a central server must also have tagged information, either “jazz”, “classical music” or “pop”. For instance, one message might be “On the 23rd of October a party with music from Michael Jackson takes place on 42nd Street” with the attached value “pop”.

According to the subscriber's selections at the time of subscribing, they may receive this message or they may not. For example, a subscriber who subscribed to the infoservice “Party NYC” may have decided that he will only receive messages with the tagged value “jazz”. In this case, he will therefore not receive the message about the party on 42nd Street with music from Michael Jackson.

Once the user such as the initiator has selected these various tagging options, the user can select button 681 to continue.

In addition, the user such as the initiator of an information service can also define the information service or provided information or messages to have a certain structure. For example, a user such as an initiator can select from predefined structure elements of an information service as shown in FIG. 11B. A selection screen or webpage 684 can be presented which includes check boxes for selecting the structure elements date 686, name 688, time 690, location 692, description 694, price 695, or other structure elements 696. Once the initiator has selected the structure elements he can continue onto another screen via button 698.

After the structure elements have been set, messages or provided information have to follow this structure. For example, an initiator may define that the information service has the structure elements date 704, name 706, and location 708, as shown in screen 700 in FIG. 11C. Provided information or messages must be in this format. In FIG. 11C one provided message is shown in row 710, other messages can be in rows 712 or 714 etc.

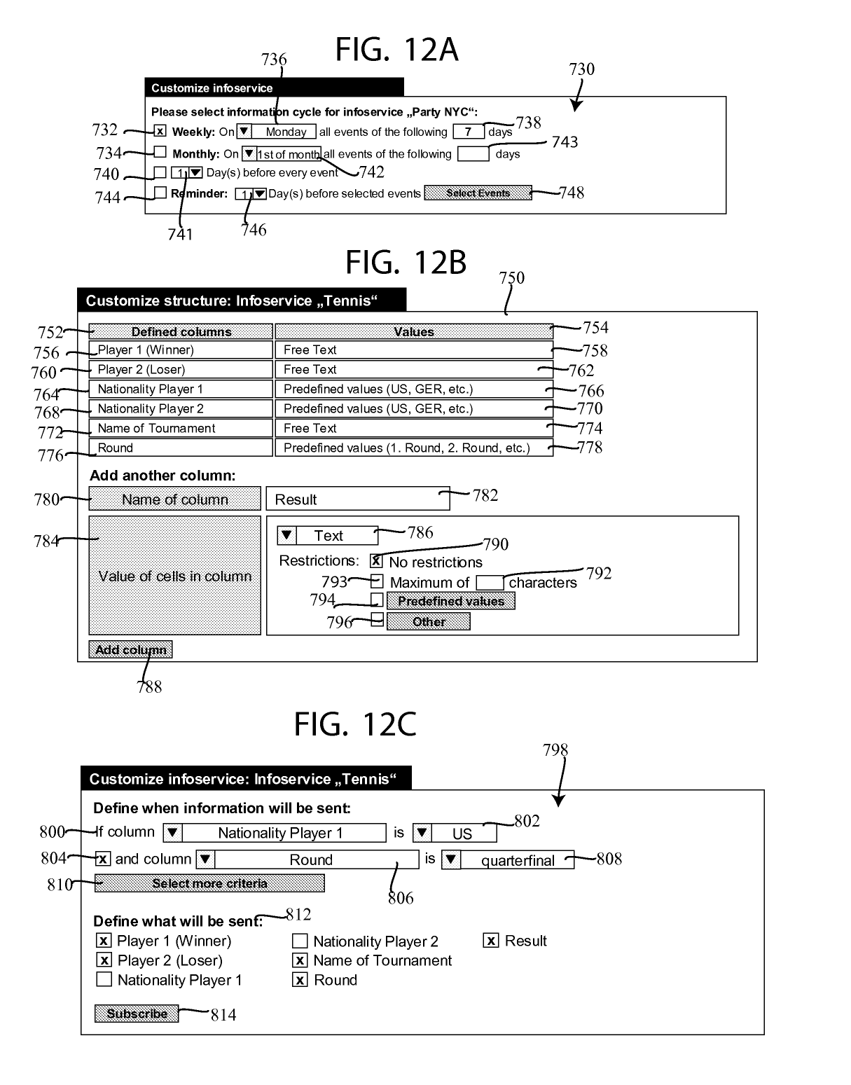

Based on this defined structure subscribers then can customize the information service. For example, as shown in FIG. 12A, there is a screen 730 which allows a subscriber to select the frequency for receiving these messages. For example, there is a series of selection boxes 732, 734, 736, 738, 740, 741, 742, 743, 744, 746 which allow a user to select when he wishes to receive a message. There is also a button 748 which can be used to allow a user to opt for reminders for different selected events.

In addition, users such as an initiator can completely define the format and the structure elements of an information service according to his or her needs. For example, FIG. 12B discloses a screen 750 wherein the user has already defined the structure elements 752, as well as their formats 754 or possible values as shown in sections numbered 756-778.

Another section of this website 750 includes a column 780 which allows a user to define the name of an additional column or structure element of the information service. For example, as shown in section 782 the user has already entered the name “result” for another column or structure element. In section 784 the user defines the format 786 and restrictions of values in the new column or structure element such as no restrictions 790, a maximum of a characters 793 which can be defined in a fill in blank 792 or predefined values 794 or other 796.

FIG. 12C discloses a screen 798 which allows a subscriber to select the criteria for when and what information they will receive in this information service. For example, there is a pulldown bar 800 allowing a user to select the type of criteria such as the nationality of a player, wherein particular characteristics of that criteria can be selected in pull down bar 802.

There is also a checkbox 804 which can be used to in conjunction with a pulldown bar 806 to further define this criteria such as the round of the match. There is also a pulldown bar allowing a user to select particular characteristics of this criteria 808. A button 810 is also available for a user to select additional criteria.

A listing 812 of checkboxes can be presented to allow a user what information will be sent. Finally there can be a button 814 to allow a user to subscribe to this information service.

Ultimately, this system and process can be used to allow to structure the sending of information while allowing subscribers to subscribe to the sending or display of information, while having a controlling system control or regulate the exchange of this information to create an improved system and process for the transfer of this information.

Accordingly, while a few embodiments of the present invention have been shown and described, it is to be understood that many changes and modifications may be made thereunto without departing from the spirit and scope of the invention as defined in the appended claims.

What is claimed is:

1. A process for controlling the sending of information to subscribers comprising:
a.) initiating an information service by an initiator;
b) said initiator setting a maximum number of messages that can be sent in said information service;
c) subscribing at least one subscriber to said information service;
d) setting a change restriction on the maximum number of messages that can be sent after said maximum number has been set;
e) sending at least one message to said at least one subscriber wherein the number of messages sent is limited by the maximum number of messages allowed.

2. The process as in claim 1, wherein said initiator initiates said information service through the internet such as a website.

3. The process as in claim 2, further comprising said initiator setting a limit to the amount of information that can be sent per message in said information service; and setting a change restriction on the limit of amount of information that can be sent after said limit to the amount of information has been set;

4. The process as in claim 3, wherein the amount of information can refer to length of messages, number of pictures, size of attached documents.

5. The process as in claim 2, further comprising providing a link that leads to a subscription page to allow subscribers to subscribe to the information service.

6. The process as in claim 2, further comprising providing a link wherein when a potential subscriber clicks on said link said potential subscriber is automatically subscribed.

7. The process as in claim 6, wherein said link is provided on a website not affiliated with the central provider that hosts the service.

8. The process as in claim 2, further comprising the step of bundling information in at least one message such that at least one message being sent to at least one subscriber includes information relating to at least two information services.

9. The process as in claim 8, further comprising the initiator setting a limit to the amount of information that can be sent per message in said information service; and setting a change restriction on the limit of amount of information that can be sent after said limit to the amount of information has been set.

10. The process as in claim 9, further comprising the step of defining a time in the future by an informer for at least one message to be sent.

11. The process as in claim 9, further comprising the step of allowing subscribers to select a time when they will receive bundled information from at least two information services in one single message.

12. The process as in claim 2, wherein said step of setting a maximum number of messages that can be sent includes a maximum number of messages that can be sent per defined time period.

13. The process as in claim 12, wherein said step of setting a maximum number of messages that can be sent includes a maximum number of messages that can be sent based upon a monthly time period.

14. The process as in claim 12, wherein said step of setting a maximum number of messages that can be sent includes a maximum number of messages that can be sent based upon a time period of more than 32 days.

15. The process as in claim 2, wherein said step of setting a maximum number of messages that can be sent includes setting a total number of messages that can be sent.

16. The process as in claim 2, further comprising the step of defining who is eligible to provide information for at least one information service.

17. The process as in claim 16, wherein said step of defining who is eligible to provide information includes selecting an individual informer by said initiator.

18. The process as in claim 16, wherein said step of defining who is eligible to provide information includes allowing members from a particular group to provide information.

19. The process as in claim 16, wherein said step of defining who is eligible includes at least one of the following: informers ratings, indemnification status of informer.

20. The process as in claim 2, further comprising the step of defining who is eligible to subscribe to an information service by said initiator.

21. The process as in claim 20, where the definition of who is eligible to subscribe to an information service is based on payments.

22. The process as in claim 21, wherein said definition of who is eligible to subscribe to an information service is performed by the initiator who can be any person with internet access unless explicitly excluded from participation.

23. The process as in claim 20, where the definition of who is eligible to subscribe to an information service is based on membership of a particular group.

24. The process as in claim 2, wherein at least two information services are listed on a single, public website where subscribers can subscribe.

25. The process as in claim 2, wherein at least thirty informers provide information for at least thirty information services.

26. The process as in claim 2, wherein the initiation of an information service can be performed by any person with internet access unless explicitly excluded from participation.

27. The process as in claim 2, further comprising the step of defining a point in time in the future by an informer for at least one message to be sent.

28. The process as in claim 2, wherein informers can provide information by at least one of the following means: email, sms, mms, rss, website.

29. The process as in claim 2, further comprising the step of presenting subscribers with a choice of a delivery channel of at least one message from at least one information service.

30. The process as in claim 2, further comprising the step of setting a predefined message that cannot be changed later.

31. The process as in claim 2, further comprising the step of publishing the maximum number of messages that can be sent by an information service on a public website.

32. The process as in claim 31, further comprising the step of publishing the maximum amount of information that can be sent per message of an information service on said public website so that there is a public website with both information concerning the maximum number of messages that can be sent by an information service and information concerning the maximum amount of information that can be sent per message of said information service.

33. The process as in claim 2, wherein the delivery channel of at least one message is a delivery to a mobile phone or device such as sms.

34. The process as in claim 2, wherein the setting of a maximum number of messages that can be sent is done for at least two information services by at least two different initiators so that there are at least two information services with different characteristics concerning the maximum number of messages that can be sent initiated by at least two different initiators.

35. A process for controlling the sending of information to subscribers comprising:
a) initiating an information service by an initiator through the internet such as a website;
b) providing information by said initiator for said information service for giving a clear indication of the number of messages intended to be sent in said information service on a website which is specifically designed for this purpose;
c) subscribing at least one subscriber to said information service;
d) sending at least one message to said at least one subscriber;
e) registering differences in the intended number of messages and actually sent number of messages.

36. The process as in claim 35, wherein said step of giving a clear indication of the number of messages to be sent includes setting a maximum number of messages intended to be sent.

37. The process as in claim 35, wherein a difference between the intended number of messages to be sent and the actual number of messages sent automatically leads to punishments concerning at least one of the following categories: informer rating, payments.

38. The process as in claim 35, further comprising said initiator setting a limit to the amount of information that can be sent per message in said information service; and setting a change restriction on the limit of amount of information that can be sent after said limit to the amount of information has been set;

39. The process as in claim 35, further comprising the step of bundling information in at least one message such that at least one message being sent to at least one subscriber includes information relating to at least two information services.

40. A process for controlling the sending of information to subscribers comprising:
a) initiating an information service by an initiator through the internet such as a website;
b) defining who is eligible to provide information for said information service which must include at least one of the following characteristics of an informer: ratings, indemnification status;
c) subscribing at least one subscriber to said information service;
d) providing information for at least one message of said information service by at least one eligible informer;
e) sending said at least one message to said at least one subscriber;

41. The process as in claim 40, further comprising the step of allowing subscribers to rate an informer or to rate at least one message provided by at least one informer.

42. The process as in claim 41, wherein said step of allowing subscribers to rate at least one message includes providing a link associated with at least one message to allow at least one subscriber to rate said at least one message.

43. The process as in claim 41, wherein a negative rating automatically leads to a punishment of at least one informer concerning at least one of the following categories: rating, payment, exclusion from participation.

44. The process as in claim 40, further comprising said initiator setting a maximum number of messages that can be sent in said information service and setting a change restriction on the maximum number of messages that can be sent after said maximum number has been set.

45. The process as in claim 40, further comprising the step of bundling information in at least one message such that at least one message being sent to at least one subscriber includes information relating to at least two information services.

46. The process as in claim 40, wherein the definition of who is eligible to provide information is performed by the initiator.

47. A process for controlling the sending of information to subscribers comprising:
a) initiating an information service by an initiator through the internet such as a website;
b) registering at least one informer;
c) setting up a value account for at least one informer;
d) subscribing at least one subscriber to said information service;
e) sending at least one message to said at least one subscriber;
f) raising the account's value of said at least one informer who provided information for said at least one message;

48. The process as in claim 47, wherein the extent to which the informer's account is raised directly depends upon the cost of the information service or message or messages to subscribers.

49. The process as in claim 47, wherein the extent to which the informer's account is raised directly depends upon advertising revenues caused by the information service or message or messages.

50. The process as in claim 47, wherein the account's value is reduced in exchange for a money payment to the respective informer.

51. The process as in claim 47, wherein any entity with internet access can initiate an information service and define the cost of said information service to subscribers unless explicitly excluded from participation.

52. The process as in claim 47, further comprising said initiator setting a maximum number of messages that can be sent in said information service; and setting a change restriction on the maximum number of messages that can be sent after said maximum number has been set.

53. The process as in claim 47, further comprising the step of bundling information in at least one message such that at least one message being sent to at least one subscriber includes information relating to at least two information services.

54. A process for controlling the sending of information to subscribers comprising:
a) initiating an information service by an initiator through a website;
b) subscribing at least one subscriber to said information service;
c) providing information to said information service by at least one informer;
d) confirming of said provided information by at least two informers other than the informer who provided the initial information;
e) sending at least one message with said confirmed information to said at least one subscriber;

55. The process as in claim 54, wherein confirmations can only be made by selected entities or member of particular groups.

56. The process as in claim 54, wherein the confirmations are made on a website which is especially designed for this purpose.

57. The process as in claim 54, wherein a message is sent to a selected part of subscribers of said information service in which the subscribers are asked to confirm said provided information relating to said information service;

58. The process as in claim 57, wherein the decision which of the subscribers are asked to confirm the provided information is based on at least one of the following: rating, date of last request to confirm other provided information, number of subscribed information services, date of subscription;

59. The process as in claim 54, wherein the sending of said at least one message to said at least one subscriber depends on at least one of the following: certain number of confirmations required, informers rating.

60. The process as in claim 54, further comprising said initiator setting a maximum number of messages that can be sent in said information service; and setting a change restriction on the maximum number of messages that can be sent after said maximum number has been set.

61. The process as in claim 54, further comprising the step of giving the subscriber the option to choose to receive at least two messages from at least two different information services in one single message.

62. A process for controlling the sending of information to subscribers comprising:
a) initiating an information service by an initiator through a website;
b) defining particular sections of the information service by said initiator;
c) subscribing at least one subscriber to said information service;
d) customizing the information service by said at least one subscriber based on the particular sections of the information service;
e) sending at least one message with customized information based on said subscribers selections to said at least one subscriber;

63. The process as in claim 62, wherein said particular sections are composed of at least one section for the actual message and at least one further section for attaching additional information to at least one message belonging to at least one information service.

64. The process as in claim 62, wherein said initiator can choose from predefined sections with certain formats for the information service.

65. The process as in claim 62, wherein the said initiator can define the sections and their formats for the information service.

66. The process as in claim 62, further comprising said initiator setting a maximum number of messages that can be sent in said information service; and setting a change restriction on the maximum number of messages that can be sent after said maximum number has been set;

67. The process as in claim 62, further comprising the step of giving the subscriber the option to choose to receive at least two messages from at least two different information services in one single message.
